(19) United States
(12) Patent Application Publication
(10) Pub. No.: US 2020/0384825 A1
(43) Pub. Date: Dec. 10, 2020

(54) TRANSPORTATION VEHICLE CLIMATE CONTROL UNIT WITH AIR CONTAMINANT DETECTION

(71) Applicant: CARRIER CORPORATION, Palm Beach Gardens, FL (US)

(72) Inventor: Greg W. TURNER, Nicholson, GA (US)

(21) Appl. No.: 16/867,019

(22) Filed: May 5, 2020

Related U.S. Application Data
(60) Provisional application No. 62/857,891, filed on Jun. 6, 2019.

(51) Int. Cl. B60H 1/00; B60Q 5/00; E05F 15/72; G08B 17/10; G08B 21/14

(52) U.S. Cl. CPC B60H 1/008; B60Q 5/005; E05F 15/72; E05Y 2900/55; G08B 21/14; E05Y 2400/52; E05Y 2400/44; G08B 17/10

(57) ABSTRACT

An illustrative example embodiment of a climate control system for a transport vehicle includes an air handler configured to move air through for establishing a selected temperature in a cabin of the vehicle. A detector is associated with the climate control unit. The detector is configured to detect at least one of smoke and carbon monoxide in the cabin of the vehicle. A controller receives an indication from the detector and is configured to determine when smoke or carbon monoxide is detected. The controller is configured to provide an alarm when a detected level exceeds a preset threshold.

### CROSS-REFERENCE TO RELATED APPLICATION

This application claims priority to U.S. Provisional Application No. 62/857,891, which was filed on Jun. 6, 2019.

### BACKGROUND

Transportation vehicles, such as trucks, may include a climate control unit for the cabin and a refrigeration system for the trailer. Each of those typically is powered by an auxiliary power unit, which provides electrical power when the main vehicle engine is not in use. The climate control unit typically provides air conditioning and heat within the cabin of the vehicle, which may useful while the vehicle is stationary.

### SUMMARY

An illustrative example embodiment of a climate control system for a transport vehicle includes an air handler configured to move air for establishing a selected temperature in a cabin of the vehicle. A detector is associated with the climate control unit. The detector is configured to detect at least one of smoke and carbon monoxide in the cabin of the vehicle. A controller receives an indication from the detector and is configured to determine when smoke or carbon monoxide is detected. The controller is configured to provide an alarm when a detected level exceeds a preset threshold.

In an example embodiment having one or more features of the climate control system of the previous paragraph, the detector is configured to detect both of smoke and carbon monoxide.

In an example embodiment having one or more features of the climate control system of any of the previous paragraphs, the detector comprises a first detection unit configured to detect smoke and a second detection unit configured to detect carbon monoxide.

In an example embodiment having one or more features of the climate control system of any of the previous paragraphs, the detector is at least partially within the air handler.

In an example embodiment having one or more features of the climate control system of any of the previous paragraphs, the detector is at least partially within the at least one duct.

In an example embodiment having one or more features of the climate control system of any of the previous paragraphs, the at least one duct is a return air duct that carries air from the cabin of the vehicle toward the air handler.

An example embodiment having one or more features of the climate control system of any of the previous paragraphs includes an auxiliary power unit that provides electrical power to the air handler and wherein the controller controls operation of the auxiliary power unit and the air handler based on the indication from the detector.

In an example embodiment having one or more features of the climate control system of any of the previous paragraphs, the vehicle includes at least one window and the controller automatically opens the at least one window in response to determining that the detected level exceeds the preset threshold.

In an example embodiment having one or more features of the climate control system of any of the previous paragraphs, the controller is configured to provide the alarm by controlling at least one of a horn of the vehicle and a user interface of the climate control system.

In an example embodiment having one or more features of the climate control system of any of the previous paragraphs, the air handler includes a fan that moves air through the at least one duct at least into the cabin of the vehicle and the controller controls operation of the fan based on the indication from the detector.

The various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of a vehicle including a climate control unit with associated air contaminant detectors designed according to an embodiment of this disclosure.

### DETAILED DESCRIPTION

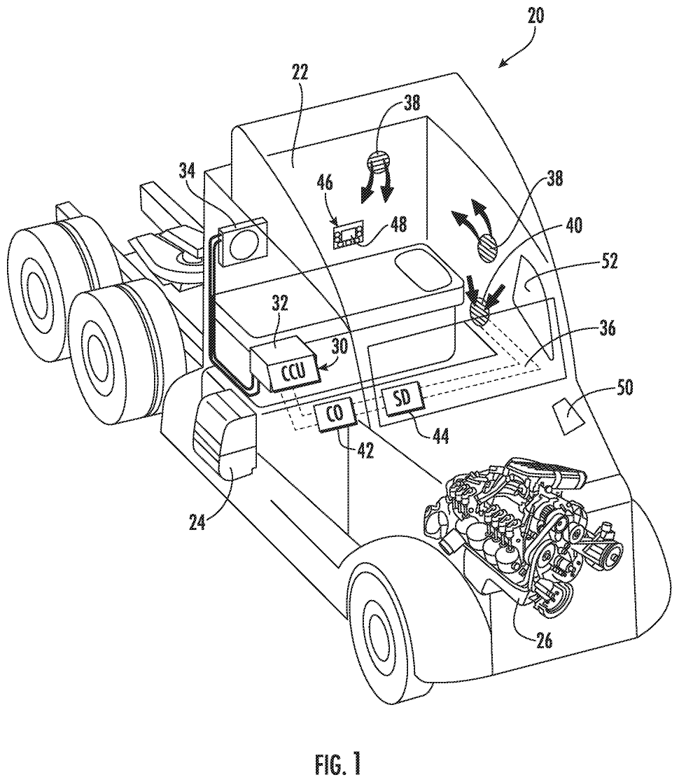

FIG. 1 schematically illustrates a transport vehicle 20, which in this example is a truck tractor. The vehicle 20 includes a cabin 22. An auxiliary power unit (APU) 24 provides electrical power for use within the cabin 22 under a variety of circumstances, including when the vehicle 20 is stationary and the vehicle main engine 26 is turned off.

A climate control unit (CCU) 30 is situated at least partially within the cabin 22 for establishing a desired or selected temperature within the cabin 22. The CCU 30 includes an air handler 32 and a condenser 34 to provide air conditioning or cooling within the cabin 22. The CCU 30 is also capable of providing heat within the example cabin 22.

The air handler 30 includes a fan, for example, for moving air through at least one duct 36 to introduce warm or cold air through outlets 38 into the cabin 22. In FIG. 1, the example duct 36 is an air return duct that directs air from a return vent 40 inside the cabin 22 toward the air handler 32.

The climate control unit 30 has at least one detector 42, 44 associated with it. The detector 42 is a carbon monoxide detector that is configured to detect the presence of carbon monoxide within air. The detector 44 is a smoke detector configured to detect the presence of smoke. While the detectors 42, 44 are schematically illustrated separately in FIG. 1, a single or combination detector unit is included in some embodiments.

Having the carbon monoxide detector 42 and smoke detector 44 associated with the climate control unit 30 allows for monitoring the presence of carbon monoxide, smoke or both within the cabin 22 based on air that is processed through the climate control unit 30. In the illustration, the detectors 42 and 44 are shown situated at least partially within the air return duct 36. Other positions of the detectors 42, 44 are possible for monitoring the presence of carbon monoxide, smoke or both in the air that is processed by the climate control unit 30.

A controller 46 is configured to operate the climate control unit 30 based on selections made by a user through a user interface 48. The controller 46 receives an indication from the detectors 42, 44 and determines whether a level of carbon monoxide, smoke or both within the cabin 22 exceeds a predetermined threshold. If so, the controller 46 provides an alarm or alert to an individual in the cabin 22 regarding the detected level. In the illustrated embodiment, the controller 46 provides an alarm or notification by activating the user interface 48 to emit sound. In the illustrated example, the controller 46 is also configured to activate a vehicle horn 50 to provide an audible alarm or alert when a detected level of carbon monoxide, smoke or both exceeds a threshold.

The controller 46 in the illustrated example is also configured to automatically control the position of a window 52 of the vehicle 20. In the event that an undesirably high level of smoke or carbon monoxide has been detected, the controller 46 automatically at least partially opens the window 52 to increase ventilation within the cabin 22 under appropriate circumstances.

Including a detector 42, 44 in association with the climate control unit 30 provides the ability to monitor contaminants in the air within the vehicle cabin 22, such as carbon monoxide or smoke. The detector 42, 44 can be integrated with the climate control unit 30 or associated components, such as the duct 36, in a manner that does not require alteration of the vehicle cabin 22 and places the sensor in a position where it will be less likely to be tampered with or damaged.

The controller 46 controls operation of the air handler to assist in detecting the presence of carbon monoxide or smoke within the cabin 22. In some situations, when the air handler 32 is not currently operating for purposes of providing heat or cooling, the controller 46 may selectively cause the fan of the air handler 32 to operate to circulate air through the climate control unit 30 for purposes of being able to monitor the quality of the air within the cabin 22 and detect the presence of smoke or carbon monoxide.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A climate control system for a transport vehicle, comprising:
an air handler configured to move air through at least one duct for establishing a selected temperature in a cabin of the vehicle;
a detector associated with at least one of the air handler or the at least one duct, the detector being configured to detect at least one of smoke and carbon monoxide in air within the cabin of the vehicle; and
a controller that receives an indication from the detector, the controller being configured to determine when the at least one of smoke and carbon monoxide is detected and to provide an alarm when a detected level exceeds a preset threshold.

2. The climate control system of claim 1, wherein the detector is configured to detect both of smoke and carbon monoxide.

3. The climate control system of claim 2, wherein the detector comprises a first detection unit configured to detect smoke and a second detection unit configured to detect carbon monoxide.

4. The climate control system of claim 1, wherein the detector is at least partially within the air handler.

5. The climate control system of claim 1, wherein the detector is at least partially within the at least one duct.

6. The climate control system of claim 5, wherein the at least one duct is a return air duct that carries air from the cabin of the vehicle toward the air handler.

7. The climate control system of claim 1, comprising an auxiliary power unit that provides electrical power to the air handler and wherein the controller controls operation of the auxiliary power unit and the air handler based on the indication from the detector.

8. The climate control system of claim 1, wherein the vehicle includes at least one window and the controller automatically opens the at least one window in response to determining that the detected level exceeds the preset threshold.

9. The climate control system of claim 1, wherein the controller is configured to provide the alarm by controlling at least one of a horn of the vehicle and a user interface of the climate control system.

10. The climate control system of claim 1, wherein
the air handler includes a fan that moves air through the at least one duct at least into the cabin of the vehicle; and
the controller controls operation of the fan based on the indication from the detector.
